(19) United States
(12) Patent Application Publication
(10) Pub. No.: US 2013/0014519 A1
(43) Pub. Date: Jan. 17, 2013

(54) METHOD AND CUP FOR OPERATION OF FROZEN BEVERAGE DEVICE

(71) Applicant: Alfio Bucceri, Hamilton (AU)

(72) Inventor: Alfio Bucceri, Hamilton (AU)

(73) Assignee: HYDRO-TURBINE DEVELOPMENTS PTY LTD, HAMILTON, QN (AU)

(21) Appl. No.: 13/518,218

(22) PCT Filed: Feb. 22, 2012
(86) PCT No.: PCT/AU12/00169

§ 371 Date: Aug. 30, 2012

(30) Foreign Application Priority Data
Feb. 21, 2011 (AU) 2011 900 582

(51) Int. Cl. A23L 3/36; F16J 15/02

(52) U.S. Cl. 62/66; 62/340; 277/637; 277/634

(57) ABSTRACT

A frozen beverage device to convert a liquid beverage into a semi-frozen or frozen form has inner and outer walls forming a refrigerant cavity containing a refrigerant material with a freezing point below the freezing point of the liquid, the refrigerant material occupying at least 80% of the volume of the refrigerant cavity. The outer wall has a base portion which can be moved from a first position, where the liquid is at least semi-frozen, to a second position where the internal pressure in the refrigerant cavity urges the inner wall outwardly towards the outer wall so that the refrigerant material contacts a maximum area of the surface of the inner wall in the refrigerant cavity for maximum heat transfer and to minimise constriction of access to the frozen beverage. Alternative methods to seal the inner and outer walls to close the refrigerant cavity are also disclosed.

### BACKGROUND OF THE INVENTION

1. Field of the Invention

THIS INVENTION relates to an improved method and cup for operation of a frozen beverage device; and to methods of producing frozen beverages using the device.

The invention is particularly suitable for, but not limited to, apparatus for making frozen beverages in semi-frozen “slurry” or “slushie” form; and to such a frozen beverage device which may be used as a toy or plaything.

Throughout the specification, the term “slurry” shall be used to include a mixture of liquid/semi-liquid, liquid/frozen and/or semi-liquid/frozen portions of the liquid.

2. Prior Art

Machines to produce so-called “slurry”-type drinks, e.g., of well-known beverages such as “Coca-Cola”, “Pepsi Cola” and “Schweppes Lemonade” (all registered trade marks) are well-known and commonly found in take-away food outlets and convenience stores. However, these machines are expensive to manufacture and install; and are not suitable for, e.g., domestic use; or for the manufacture of a wide range of “slurry”-style beverages, including alcoholic beverages such as cocktails.

International Patent Application PCT/AU2005/001895 (=International Publication WO 2006/063401) (Bucceri, Alfio) disclosed a method of and apparatus for converting a liquid in a container to a semi-frozen slurry or to frozen ice particles.

The freezing device was a purposely-designed cup capable of holding a refrigerant between 2 flexible walls; and could be provided in numerous sizes and shapes.

The refrigerant between the walls of the cup consisted of salt and water, or a similar brine-type solution, that lowers the freezing temperature of the solution. The refrigerant was placed between the walls, and air was excluded before sealing the two walls of the cup that was formed.

In this way, a vacuum was formed between the walls which allowed for the refrigerant to be disbursed high onto the side walls of the cup or vessel, or other freezing means, and then a beverage was added to be chilled or frozen.

The cup was then subjected to squeezing by the consumer's hands for a pre-determined period of time, and the beverage was quickly chilled, or could be totally or partially frozen. The beverage was then ready for consumption.

It was found that when using that apparatus and method, the refrigerant between the wall cavities would drop by gravity to the bottom of the cup, and create a pressure on the flexible and pliable inner wall.

The inner wall was made from flexible pliable material such as silicon, TPU, PE, EVA, thin-sheeted aluminum, copper foil, or food grade polyurethane- or polyethylene material.

The problem did not affect the working of the apparatus; and during the freezing of the cup and the squeezing of the cup, the problem was not readily noticeable, and the device worked very well and did what it was designed to do during these processes.

In fact, it was the pressure of the liquid refrigerant on the flexible inner wall of the cup that made this a workable and innovative product.

During the use of the apparatus, the double-walled cup containing the refrigerant was frozen in the freezer, and the liquid coolant would fill the total void between the cup walls to ensure that heat transfer occurred to all parts of the inner cup, from the base to the top of the cup.

The refrigerant was distributed in this manner by freezing the cup in an upside down position i.e. turning the cup upside down, when in the freezer, to ensure that the refrigerant was easily and efficiently spread.

Then, when the consumer took the cup from the freezer and filled the cup with a cold liquid and squeezed the sides, the transfer of heat caused the ice crystals that were formed on the inner wall of the apparatus to be dislodged and to float to the top of the cup. It has been shown that cup worked perfectly and efficiently in making a slushy drink in this manner.

However, in doing so, there was a problem with the cup that became relevant during the consumption of the beverage by the user.

The problem that occurred is that the melting refrigerant between the inner walls of the cup drops by gravity to the base of the cup, as the refrigerant is converted from ice to liquid and released the cold.

The inner wall of the cup would expand at the base as with the user consumed the frozen beverage and caused the amount of frozen beverage to diminish within the cup.

This caused the top of the flexible inner wall to move inwards at the top of the cup, while at the same time bulging out at the base of the cup as the liquid refrigerant in the lower side pushed against the inner wall.

The effect of this action was that the perfectly formed inner wall can now resemble a wine-glass shape with the bottom part of the inner wall constricting around the remaining frozen beverage remaining in the cup.

As this is the nature of the flexible inner wall, the result is understandable, and because of the nature of the resilient flexible material it was still possible to maneuver the spoon through the constriction to consume and retrieve the remaining e.g. 15% to 20% of the frozen beverage.

Another problem caused by the above described constriction was that the cleaning of the cup could be more difficult due to this constriction and the liquid refrigerant pressure on the base of the inner wall.

International. Patent Application PCT/AU2008/001923 (=International Publication WO 2009/079721) (Bucceri, Alfio) disclosed an alternative apparatus, and method, for converting a liquid in a closable container to a semi-frozen slurry or to frozen ice particles, where freezing devices, with thin deformable walls, contain refrigerant to form a thin layer of ice/ice crystals on the deformable walls, the ice crystals being released therefrom due to agitation of the liquid in the container by shaking/rotation and/or squeezing on the container and/or the removable closure.

Experience with the prior art devices described above has identified some limitations with those devices e.g. the frozen beverage may be difficult to remove from the container and/or the freezing period may be too slow to be acceptable to the users.

### OBJECTS OF THE PRESENT INVENTION

It is an object of the present invention to overcome, or at least ameliorate, one or more problems with the prior art devices.

Other preferred objects of the present invention will become apparent from the following description.

### SUMMARY OF THE PRESENT INVENTION

In one aspect, the present invention resides in an apparatus for converting a liquid into a semi-frozen or frozen form, including:

an outer wall and an inner wall sealably connected together to form a refrigerant cavity;

a refrigerant material at least partially filling the refrigerant cavity, the refrigerant material being able to be cooled below a freezing temperature of the liquid to at least partially-freeze the liquid to form a semi-frozen slurry and/or frozen particles when the liquid is brought into contact with the inner wall; wherein:

the inner wall is formed from a flexible liner and defines a freezing cavity for the liquid; and

the outer wall has a base portion flexibly connected to a main body portion;

so arranged that, before the refrigerant material is cooled, the base portion is moved to a first position adjacent, or at least partially within, the main body portion, and after the liquid is at least partially-frozen, the base portion is moved to a second position at or below the main body portion to cause internal pressure in the refrigerant cavity to move the inner wall towards the main body portion of the outer wall.

Preferably, the outer wall is formed of a flexible, insulating material; and

the base portion and main body portion are interconnected by a foldable connection portion, and are preferably formed integrally.

In one preferred embodiment, a link member interconnects the base portion to a lower portion of the inner wall.

Preferably, the refrigerant material occupies at least 80% of the volume of the refrigerant cavity when the base portion is in the first position, and is in contact with substantially 100% of the inner wall within the refrigerant cavity when the base position is in the second position.

In a second aspect, the present invention resides in a method of converting a liquid into a semi-frozen or frozen form, including the steps of:

cooling a refrigerant material in a refrigerator or freezer, the refrigerant material being contained in a sealed refrigerant cavity between an outer wall and a flexible inner wall of an apparatus, where a base portion of the outer wall occupies a first position and causes the inner wall to move inwardly away from the outer wall;

removing the apparatus from the refrigerator or freezer;

placing the liquid within a freezing cavity defined by the inner wall; and when the liquid is semi-frozen or frozen, moving the base portion to a second position away from the inner wall to cause internal pressure in the refrigerant cavity to move the inner wall outwardly towards a main body portion of the outer wall.

In a third aspect, the present invention resides in a method of converting a liquid into a semi-frozen or frozen form, including the steps of:

cooling a refrigerant material and the liquid in a refrigerator or freezer, the refrigerant material being contained in a sealed refrigerant cavity between an outer wall and a flexible inner wall of an apparatus, and the liquid being contained in a freezing cavity defined by the inner wall, where a base portion of the outer wall occupies a first position and causes the inner wall to move inwardly away from the outer wall;

removing the apparatus from the refrigerator or freezer when the liquid is semi-frozen or frozen; and

moving the base portion to a second position away from the inner wall to cause internal pressure in the refrigerant cavity to move the inner wall outwardly towards a main body portion of the outer wall.

In a fourth aspect, the present invention resides in a sealing assembly for an apparatus for converting a liquid into a semi-frozen or frozen form, the apparatus having an outer wall and an inner wall forming a refrigerant cavity, and each wall has an inwardly-directed peripheral flange about a respective mouth portion;

the sealing assembly including:

an inner locking ring having a tubular body with an outwardly-directed peripheral flange, the tubular body having at least one outwardly-directed locking formation; and

an outer locking ring having a body with an inner annular wall connected to an outer annular wall by a web member, the inner annular wall having at least one inwardly-directed locking formation complementary with the outwardly-directed locking formation, and the outer annular wall having a downwardly-directed rim;

so arranged that:

when the inner wall is located within the outer wall with their respective peripheral flanges co-axially aligned, and the peripheral flange of the inner locking ring wall is aligned with the rim, locking engagement of the inwardly- and-outwardly directed locking formations causes the peripheral flanges of the inner and outer walls to be sealably clamped between the peripheral flange of the inner locking ring and the rim of the outer locking ring.

Preferably, both the inner and outer walls have lip flanges about their peripheral flanges; and

the lip flanges are sealably received within the body of the outer locking ring.

In a fifth aspect, the present invention resides in a sealing assembly for an apparatus for converting a liquid into a semi-frozen or frozen form, the apparatus having an outer wall and an inner wall forming a refrigerant cavity, and each wall has an outwardly-directed peripheral flange about a respective mouth portion;

the sealing assembly including:

a top locking ring having an annular wall with an outer peripheral flange with at least one inwardly-directed locking formation; and

a bottom locking ring having an annular wall having an upper portion with a rim to be received within the outer peripheral flange, the annular wall having at least one outwardly-directed locking formation complementary to the inwardly-directed locking formation;

so arranged that:

when the inner wall is located within the outer wall with their respective peripheral flanges co-axially aligned, and the peripheral flange of the outer wall is engaged with the rim, locking engagement of the inwardly- and-outwardly directed locking formations causes the peripheral flanges of the inner and outer walls to be sealably clamped between the annular wall of the top locking ring and the rim of the bottom locking ring.

Preferably, the annular wall of the lower locking ring has an annular recess;

both the inner and outer walls have lip flanges about their peripheral flanges; and

the lip flanges are sealably received in the annular recess.

Preferably, the top locking ring further includes an inner peripheral flange, on an opposed side of the annular wall.

Preferably, the inner peripheral flange forms a lower portion of a removable cover for the apparatus, or has at least outwardly-directed locking formation for releasable engagement with a removable cover for the apparatus.

Preferably, the locking formations comprise one or more screw-threads; but may comprise bayonet coupling members or like releasable formations.

A flexible wall may overlie the mouth portions of the inner and outer walls and be darned between the annular wall of the top locking ring and the peripheral flange of the inner wall.

Preferably, the apparatus of the first aspect and/or apparatus incorporating the sealing assembly of the fourth or fifth aspects are received, and preferably enclosed, in a cover formed of semi-rigid or soft materials.

In a sixth aspect, the present invention resides in an apparatus for converting a liquid into a semi-frozen or frozen form, including:

an outer wall and an inner wall sealably connected together to form a plurality of refrigerant cavities; and

a refrigerant material at least partially filling each one of the refrigerant cavities, the refrigerant material being able to be cooled below a freezing temperature of the liquid to at least partially-freeze the liquid to form a semi-frozen slurry and/or frozen particles when the liquid is brought into contact with the inner wall.

### DETAILED DESCRIPTION OF PREFERRED EMBODIMENTS

To enable the invention to be fully understood, preferred embodiments of the present invention will now be described with reference to the accompanying drawings, in which:

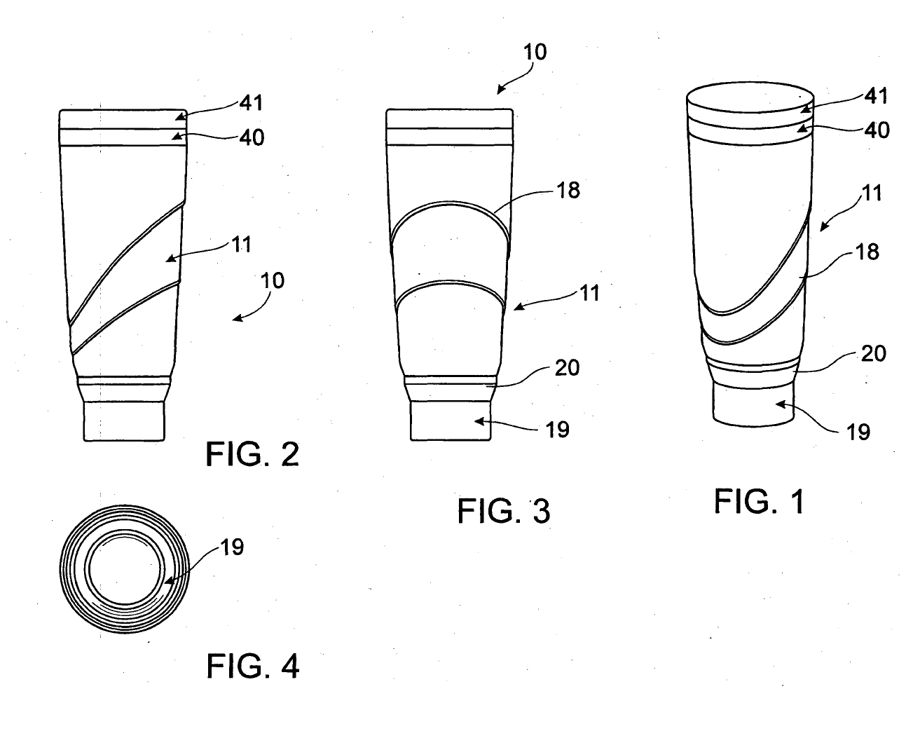

FIGS. 1 to 4 are respective perspective, first side, second side and bottom views of a first embodiment of a beverage freezing device in accordance with the present invention;

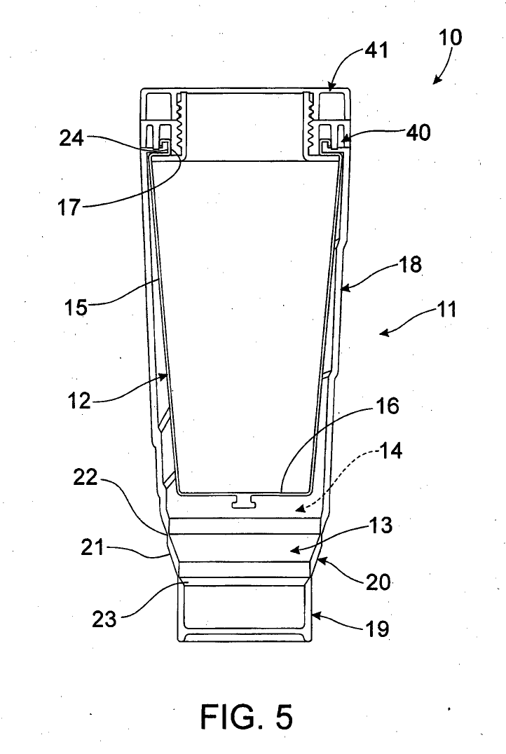

FIG. 5 is a sectional side view of the device of FIGS. 1 to 4;

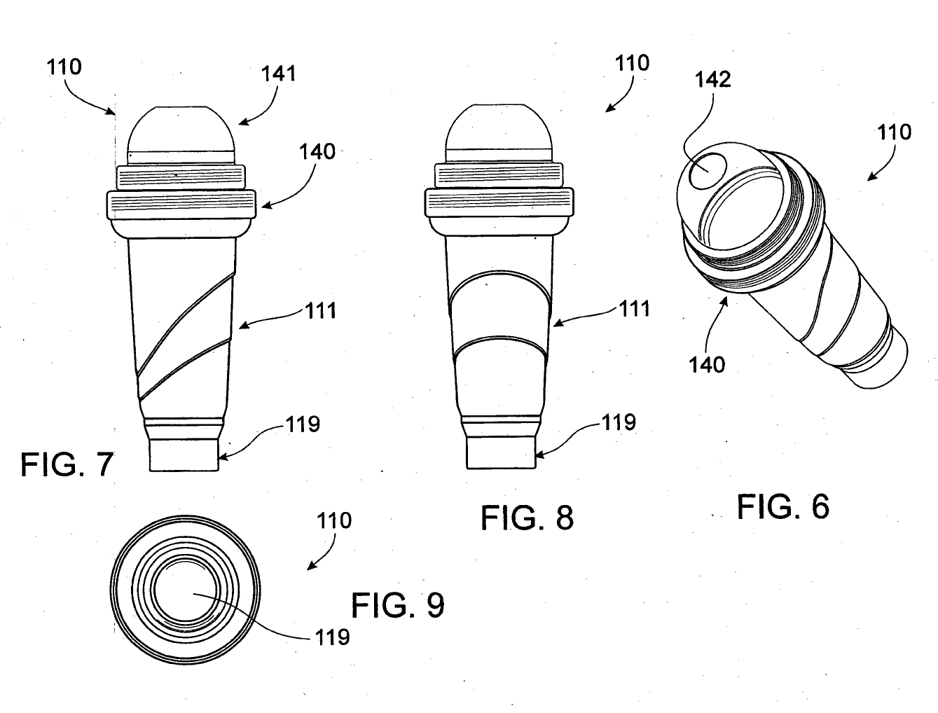

FIGS. 6 to 9 are respective perspective, first side, second side and bottom views of a second embodiment of a beverage freezing device in accordance with the present invention;

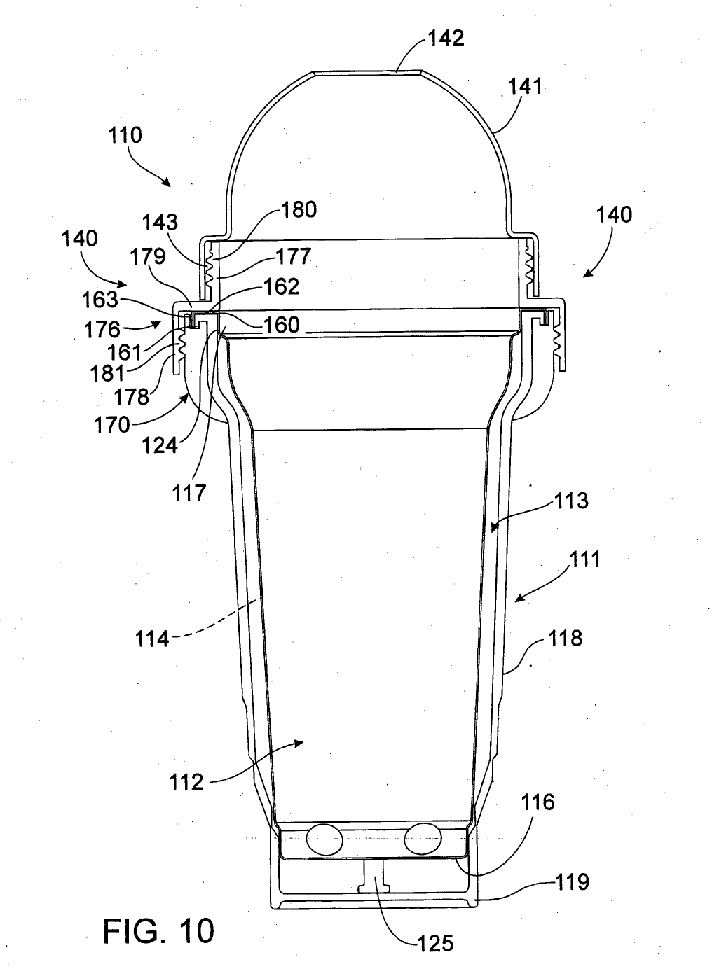

FIG. 10 is a sectional side view, with the base portion of the outer wall in the first (or raised) position;

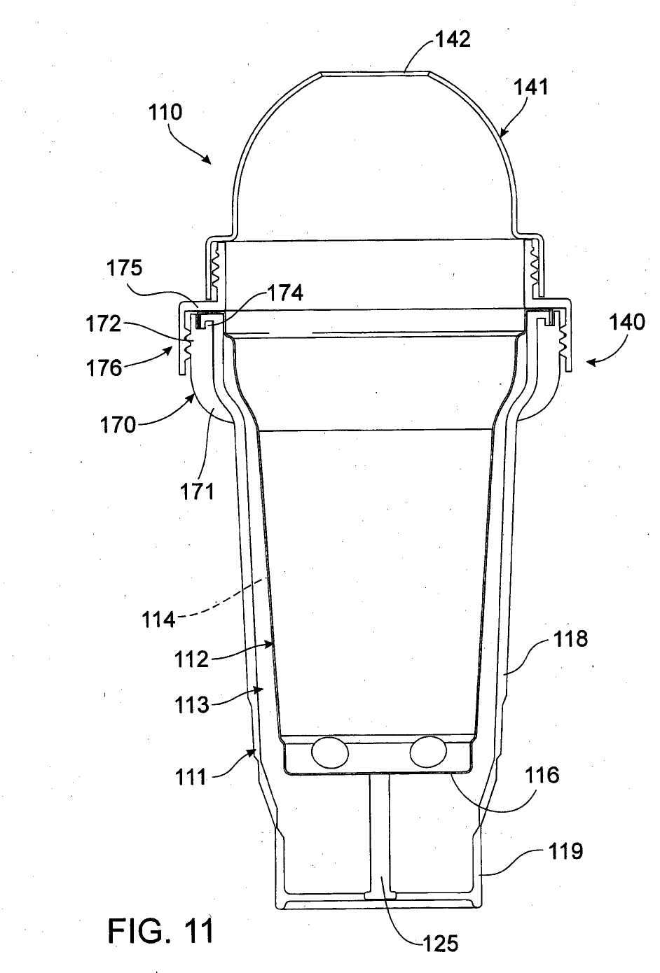

FIG. 11 is a similar view, with the base portion in the second (or lowered) position;

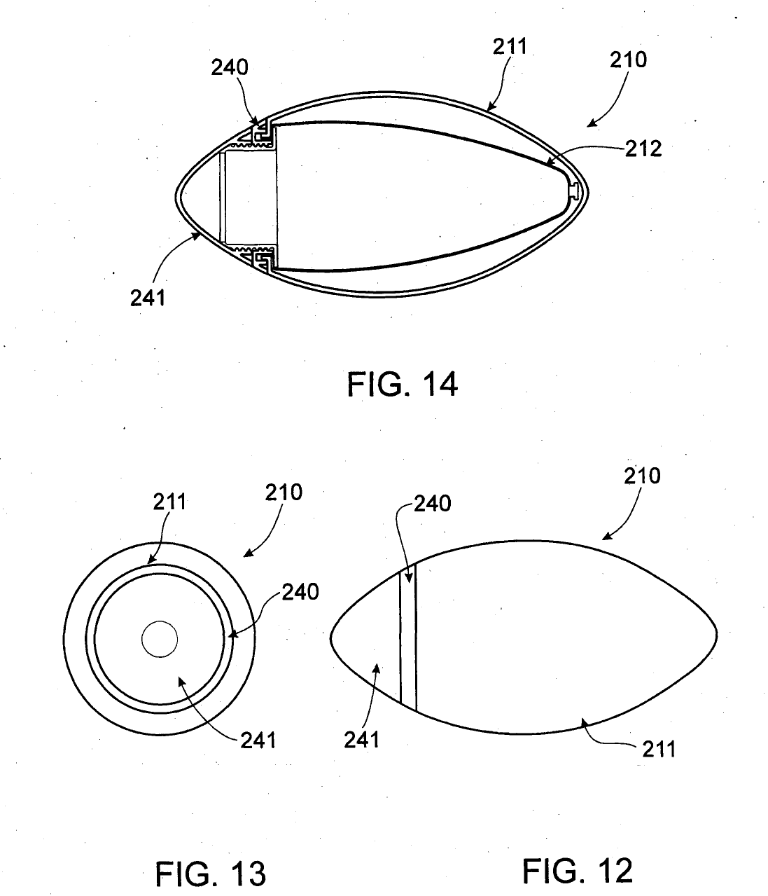

FIGS. 12 to 14 are respective side, top and part sectional side views of a third embodiment of a beverage freezing device in accordance with the present invention;

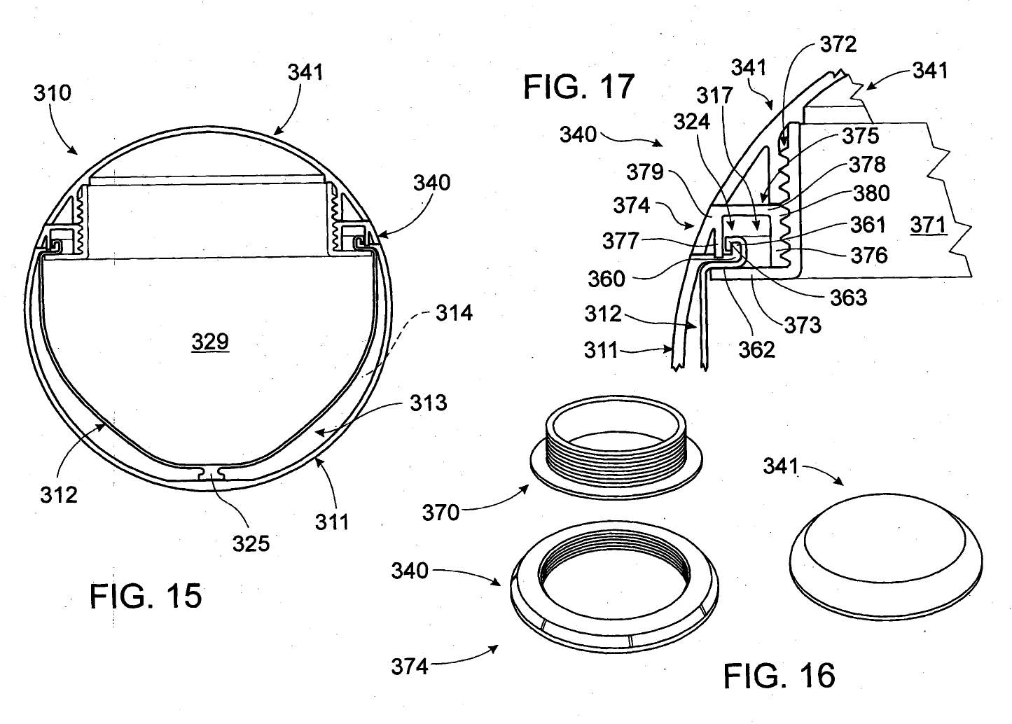

FIG. 15 is a sectional side view of a fourth embodiment of a beverage freezing device in accordance with the present invention;

FIG. 16 is a perspective view of a first embodiment of a sealing assembly for a beverage freezing device, as used in the devices of the first, third and fourth embodiments, together with a cover;

FIG. 17 is a sectional side view of the sealing assembly and cover of FIG. 16;

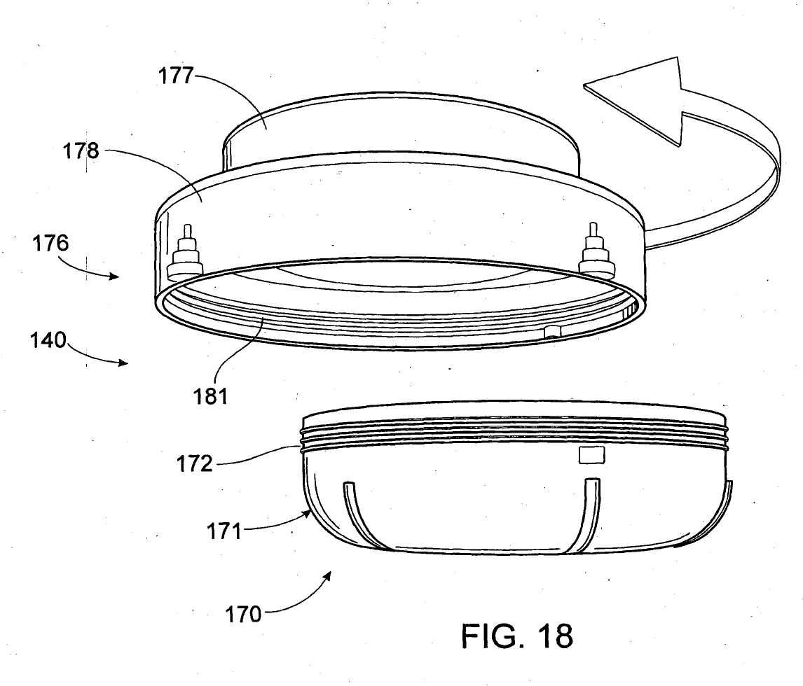

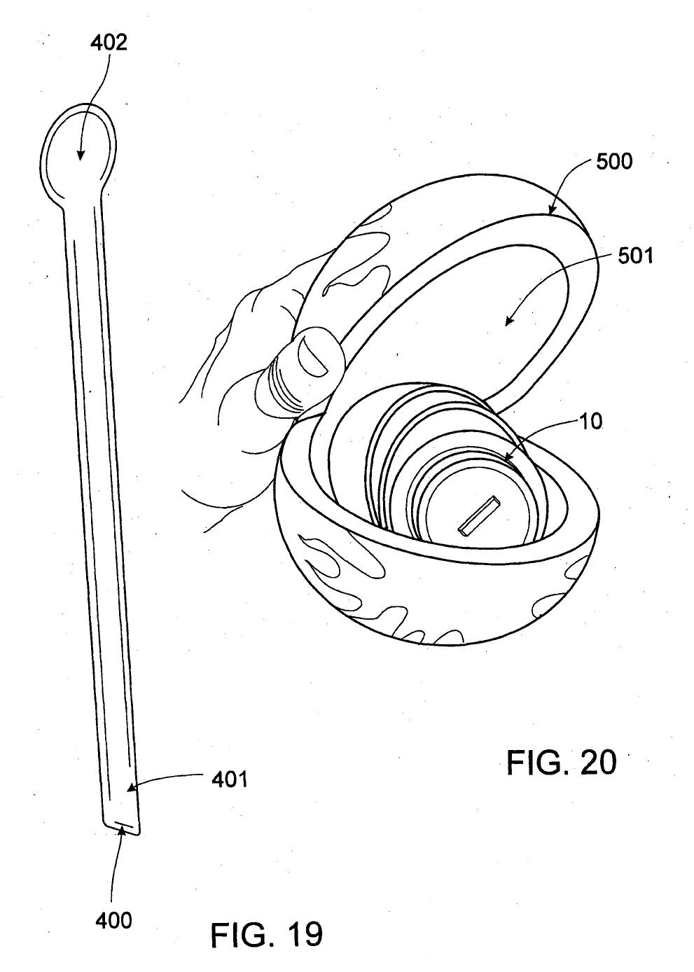

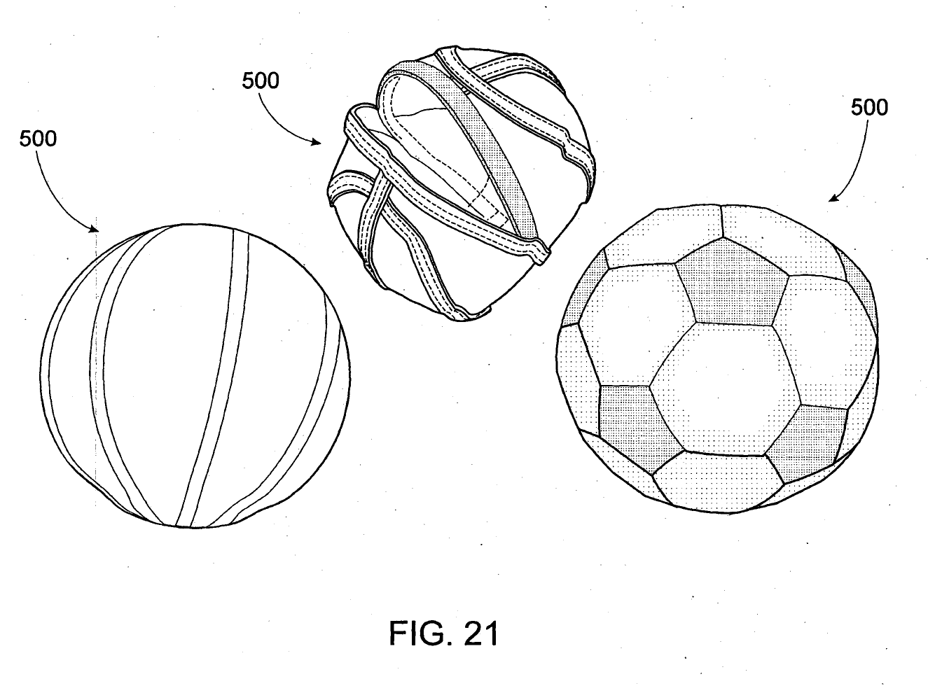

FIG. 18 is a perspective view of the locking rings of a second embodiment of a sealing assembly for a beverage freezing device, as used in the device of the second embodiment;

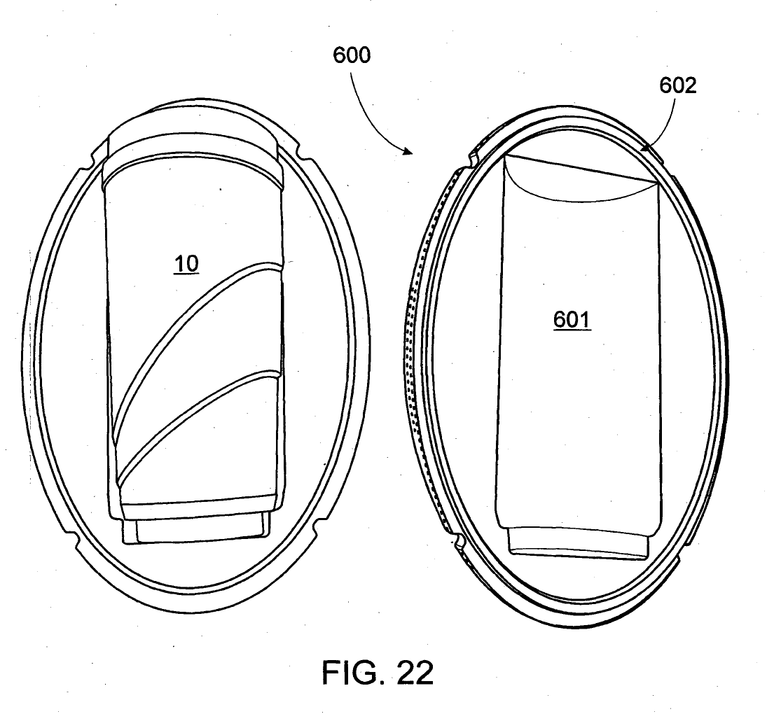

FIG. 19 is a perspective view of a refrigerant stirring spoon for use with the beverage freezing devices;

FIG. 20 is a perspective view of a beverage freezing device within a soft-fabric cover;

FIG. 21 is a perspective view of three ball-type soft-fabric covers;

FIG. 22 is a perspective view of the two halves of a semi-rigid material cover, with a beverage freezing device received in one half of the cover;

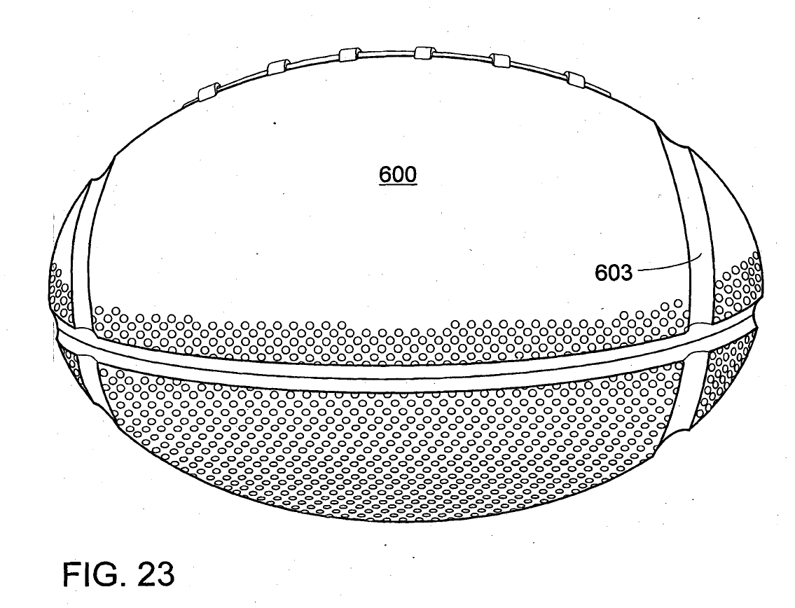

FIG. 23 is a perspective view of the cover of FIG. 23 when closed;

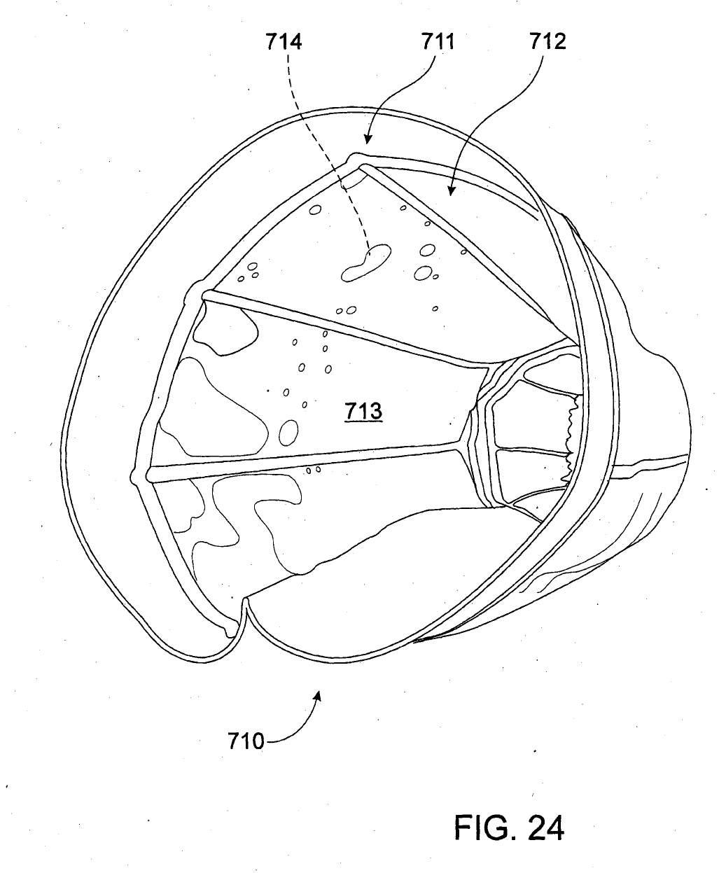

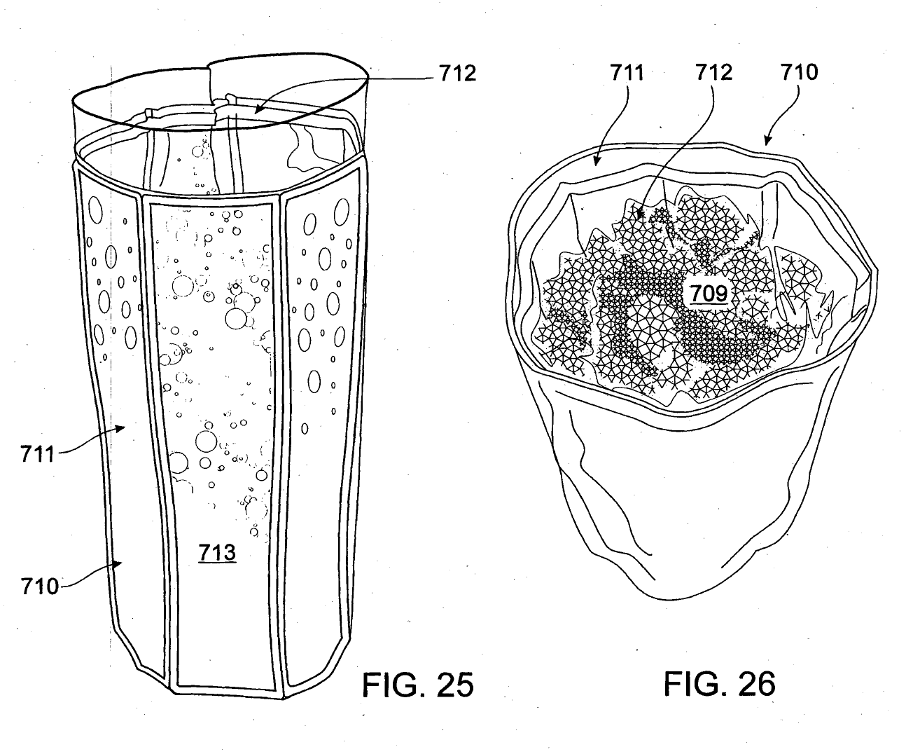

FIGS. 24 and 25 are respective top and side perspective views of a fifth embodiment of a beverage freezing device in accordance with the present invention; and

FIG. 26 is a perspective view of the device of FIGS. 24 and 25 containing a semi-frozen liquid.

### DETAILED DESCRIPTION OF THE PREFERRED EMBODIMENTS

Referring to FIGS. 1 to 5, the respective components of the beverage freezing device 10 of the first embodiment are manufactured from food-grade polymeric materials, such as silicone rubber and polyethylene.

The device 10 has an outer wall 11 and an inner wall 12 which are sealed together, as will be hereinafter described, to form a refrigerant cavity 13 containing a refrigerant material 14 e.g. a brine solution.

The inner wall 12 is formed as a thin, flexible liner, with a convergent side wall portion 15, a bottom wall portion 16, and a mouth 17.

The outer wall 11 is formed of thicker, insulating material, and has a (downwardly-convergent) main body portion 18 and a base portion 19 interconnected by a connecting portion 20. The connecting portion 20 has an intermediate portion 21 connected to the main body portion 18 and base portion 19 by respective circumferential fold lines 22, 23. The main body portion 18, base portion 19 and connecting portion 20 are formed as an integral unit. The outer wall has a mouth 24.

As will be hereinafter described in more detail with respect to FIGS. 16 and 17, the respective mouths 17, 24 of the inner and outer walls 12, 11, are sealed together by a first sealing assembly 40 of the present invention and selectively closed by a removable cover 41.

FIGS. 6 to 11 illustrate a second embodiment of a beverage freezing device 110 in accordance with the present invention. The general method of construction is similar to that of the first embodiment of FIGS. 1 to 5, except the respective mouths 117, 124 of the inner and outer walls 112, 111 are sealed together by a second sealing assembly 140 of the present invention, to be hereinafter described with reference to FIGS. 10, 11 and 18. The removable cover 141 has a hole 142 (which may be offset) to enable access to the frozen beverage in the device 110

The bottom wall portion 116 of the inner wall 112 is connected to the base portion 119 of the outer wall 111 by a flexible link 125, so that when the base portion 119 is moved from the first (or raised) position illustrated in FIG. 10 to the second (or lowered) position illustrated in FIG. 11, the bottom wall portion 116 is pulled downwardly therewith.

The liquid refrigerant material 114 in the refrigerant cavity 113 tends to force the inner wall inwardly, away from the outer wall 111, when the base portion 119 is moved to the first position. The volume of the refrigerant material 114 is at least 80%, preferably 85%+ of the volume of the refrigerant cavity 113 (but the volume of the refrigerant material, whether liquid or frozen, must not exceed the volume of the refrigerant cavity 113.

When the base portions 19, 119 are moved to their respective second positions—see FIGS. 5 and 11—the refrigerant material 13, 113 is brought into contact with substantially 100% of the side wall portion 15, 115 within the refrigerant cavity 13, 113, the internal pressure (or more correctly, vacuum) in the refrigerant cavity 13, 113 drawing the side wall portions 16, 116 of the inner wall 12, 112 outwardly towards the outer wall 11, 111.

In addition, when the base portions 19, 119 are in their second positions, the inner wall 12, 112 does not constrict access to the frozen beverage and makes cleaning of the device 10, 110 after use much easier.

The skilled addressee will appreciate that the device 10, 110 may be placed in a refrigerator or freezer to cool the refrigerant material, where the liquid is added after removal therefrom; or the liquid may be placed in the device 10, 110 before being placed in the refrigerator or freezer. In either case, on removal from the refrigerator or freezer, the consumer squeezes and/or shakes the device 10, 110 to produce a non-solid frozen beverage, and the base portion 19, 119 is moved to the second position to both maintain transfer of the cold from the inner wall 12, 112 to the frozen beverage and to improve access to the latter.

FIGS. 12 to 14 illustrate a third embodiment, where the device 210 has an elliptical, or football, shape and has a construction similar to the device 10 of FIGS. 1 to 5, except that the outer wall 211 is at least semi-rigid and the device 210 is shaken after the liquid has been placed in the freezing cavity 239 defined by the inner wall 212 and the cover 241.

In the device 210, the outer and inner walls 211, 212 are sealed together to form the refrigerant cavity 214 by the first sealing assembly 240 to be hereinafter described.

The device 310 illustrated in FIG. 15 is of similar construction to the device 10, having a substantially “spherical” ball shape, where the inner and outer walls 312, 311 may be interconnected by a flexible link 325 to enable the inner wall 312 to be moved outwardly under the internal pressure in the refrigerant cavity 313 in the manner hereinbefore described.

Alternatively, the outer wall 311 may be semi-rigid and the device 301 is shaken after the device 310 has been removed from the refrigerator or freezer and the liquid added to the freezing cavity 339.

The device 310 incorporates a first sealing assembly 340 to now be described in more detail with reference to FIGS. 16 and 17.

The device 310 has inner and outer walls 312, 311, and a removable cover 341. The mouth 324 of the outer wall 311 is defined by an inwardly-directed peripheral flange 360 and an upwardly-directed lip flange 361. The mouth 317 of the inner wall 312 is also defined by an inwardly-directed peripheral flange 362 and an inverted-L shape lip flange 363 which forms a downwardly-directed annular sealing recess 364.

An inner locking ring 370 has a tubular body 371 with external locking formations in the form of screw-threads 372. An integral peripheral flange 373 is provided around the lower end of the tubular body 371.

An outer locking ring 374 has an annular body 375 of substantially-inverted-U shape, with inner and outer body walls 376, 377 interconnected by a web member 378. NB: The annular body 375, in this embodiment, has an inclined extension 379 which fills the gap between the cover 341 and the mouth 324 of the outer wall 311. In the device 10 of the first embodiment, the extension lies parallel to the outer body wall. Inwardly-directed locking formations, in the form of screw-threads 380, are provided on the inner body wall 376 for releasable (and sealing) engagement with the screw-threads 372.

The skilled addressee will appreciate that the lip flange 361 of the outer wall 311 is received within the annular recess 364 of the inner wall 312, and that the peripheral flanges 360, 362 are clamped between the peripheral flange 373 and outer body wall 377 of the inner and outer locking rings 371, 374 to provide an effective seal closing the refrigerant cavity 313.

The cover 341 has internal screw-threads 343 for sealing engagement with the screw-threads 372 on the inner sealing ring 370.

The device 110 incorporates a second sealing assembly 140, which will now be described with reference to FIGS. 10, 11 and 18.

The mouth 124 of the outer wall 111 has an outwardly-directed peripheral flange 160 and a downwardly-directed lip flange 161. The mouth 117 of the inner wall 112 is defined by similar flanges 162, 163.

The bottom locking ring 170 has a tubular body with an annular wall 171 with external screw-threads 172. The top face of the annular wall 171 has an annular recess 173 surrounded by inner and outer circumferential rims 174, 175.

The top locking ring 176 has a tubular body with an upper annular wall 177 and a lower annular wall 178 (of larger diameter) interconnected by a peripheral flange or web-member 179. Outwardly-directed screw-threads 180 are provide about the upper annular wall 177, and inwardly-directed screw-threads 181 are provided on the lower annular wall 178 to engage the screw-threads 172 on the bottom locking ring 170. The cover 141 has screw-threads 143 to engage the screw-threads 180 to releasably secure the cover 141 to the device 110.

The skilled addressee will appreciate that the lip flanges 161, 163 of the outer and inner walls 111, 112 are received in the annular recess 173, while the peripheral flanges 160, 162 are clamped between the peripheral flange or web-member 179 and the outer circumferential rim 175 of the top and bottom locking rings 176, 170 to sealably close the mouths 124, 117 of the side walls 111, 112.

To assist the freezing of the liquid, a spoon 400 may be placed in the device 110, the spoon having a hollow shaft 401 and concave head 402 filled with a refrigerant material similar the refrigerant material hereinbefore described. The spoon 400 is placed in the refrigerator or freezer with the device; and in the liquid if the device has been filled. After the device has been removed from the refrigerator or freezer, the spoon is inserted into the liquid to assist in freezing the beverage and/or retaining the beverage in an at least semi-frozen state.

As illustrated in FIGS. 20 and 21, the device 10 may be placed in a cavity 501 on a soft-fabric cover 500 and thrown/rolled/shaken/otherwise agitated to agitate the liquid in the device to accelerate the freezing step. As illustrated in FIG. 21, the cover 500 may have a range of shapes/ornamentations, including a soccer (football) shape.

Alternatively, as illustrated in FIGS. 22 and 23, the device 10 may be placed in a cavity 601 in one half-body 602 of a semi-rigid material cover 600. The two half-bodies 602 are secured together by elastic bands (not shown) received in external grooves 603.

In a fifth embodiment, the device 710 has an outer wall 711 and an inner wall 712 which are e.g. RF welded together to form a plurality of refrigerant cavities 713. After being cooled in a refrigerator or freezer, the liquid beverage is converted to an at least semi-frozen beverage 709, the consumer squeezing the walls 711, 712 as the freezing occurs. A tubular extension on the outer wall 711, above the line of sealing with the inner wall 712, can provide a folding cover to enclose the liquid and/or frozen beverage 709.

Where the device 10, 110, 210, 310 is fitted with a cover 41, 141, 241, 341 having a hole e.g. similar to the hole 142 in cover 141, a flexible, circular, cover sheet may be clamped over the mouths of the inner walls 12, 112, 212, 312, by the sealing assemblies 40, 140, 240, 340, to prevent unwanted loss of liquid from the freezing cavity (339) in the device 10, 110, 210, 310 while it and the liquid beverage are in the refrigerator or freezer. The sealing assembly may be undone to release the cover sheet, or it may simply be perforated to provide access to the at least semi-frozen beverage for consumption.

The skilled addressee will appreciate the embodiments of the invention hereinbefore described and illustrated provide simple, efficient, relatively inexpensive, devices and methods for producing at least semi-frozen beverages.

Various changes and modifications may be made to the embodiments described and illustrated without departing from the present invention.

1. An apparatus for converting a liquid into a semi-frozen or frozen form, including:
an outer wall and an inner wall sealably connected together to form a refrigerant cavity;
a refrigerant material at least partially filling the refrigerant cavity, the refrigerant material being able to be cooled below a freezing temperature of the liquid to at least partially-freeze the liquid to form a semi-frozen slurry and/or frozen particles when the liquid is brought into contact with the inner wall; wherein:
the inner wall is formed from a flexible liner and defines a freezing cavity for the liquid; and
the outer wall has a base portion flexibly connected to a main body portion;
so arranged that, before the refrigerant material is cooled, the base portion is moved to a first position adjacent, or at least partially within, the main body portion, and after the liquid is at least partially-frozen, the base portion is moved to a second position at or below the main body portion to cause internal pressure in the refrigerant cavity to move the inner wall towards the main body portion of the outer wall.

2. The apparatus of claim 1, wherein:
the outer wall is formed of a flexible, insulating material; and
the base portion and main body portion are interconnected by a foldable connection portion, and are optionally formed integrally.

3. The apparatus of claim 1 or claim 2, wherein:
a link member interconnects the base portion to a lower portion of the inner wall.

4. The apparatus of any one of claims 1 to 3, wherein:
the refrigerant material occupies at least 80% of the volume of the refrigerant cavity when the base portion is in the first position, and is in contact with substantially 100% of the inner wall within the refrigerant cavity when the base position is in the second position.

6. A method of converting a liquid into a semi-frozen or frozen form, including the steps of:
cooling a refrigerant material in a refrigerator or freezer, the refrigerant material being contained in a sealed refrigerant cavity between an outer wall and a flexible inner wall of an apparatus, where a base portion of the outer wall occupies a first position and causes the inner wall to move inwardly away from the outer wall;
removing the apparatus from the refrigerator or freezer;
placing the liquid within a freezing cavity defined by the inner wall; and
when the liquid is semi-frozen or frozen, moving the base portion to a second position away from the inner wall to cause internal pressure in the refrigerant cavity to move the inner wall outwardly towards a main body portion of the outer wall.

7. A method of converting a liquid into a semi-frozen or frozen form, including the steps of:
cooling a refrigerant material and the liquid in a refrigerator or freezer, the refrigerant material being contained in a sealed refrigerant cavity between an outer wall and a flexible inner wall of an apparatus, and the liquid being contained in a freezing cavity defined by the inner wall, where a base portion of the outer wall occupies a first position and causes the inner wall to move inwardly away from the outer wall;
removing the apparatus from the refrigerator or freezer when the liquid is semi-frozen or frozen; and
moving the base portion to a second position away from the inner wall to cause internal pressure in the refrigerant cavity to move the inner wall outwardly towards a main body portion of the outer wall.

8. A sealing assembly for an apparatus for converting a liquid into a semi-frozen or frozen form, the apparatus having an outer wall and an inner wall forming a refrigerant cavity, and each wall has an inwardly-directed peripheral flange about a respective mouth portion;
the sealing assembly including:
an inner locking ring having a tubular body with an outwardly-directed peripheral flange, the tubular body having at least one outwardly-directed locking formation; and
an outer locking ring having a body with an inner annular wall connected to an outer annular wall by a web member, the inner annular wall having at least one inwardly-directed locking formation complementary with the outwardly-directed locking formation, and the outer annular wall having a downwardly-directed rim;
so arranged that:
when the inner wall is located within the outer wall with their respective peripheral flanges co-axially aligned, and the peripheral flange of the inner locking ring wall is aligned with the rim, locking engagement of the inwardly- and-outwardly directed locking formations causes the peripheral flanges of the inner and outer walls to be sealably clamped between the peripheral flange of the inner locking ring and the rim of the outer locking ring.

9. The sealing assembly of claim 8, wherein:
both the inner and outer walls have lip flanges about their peripheral flanges; and
the lip flanges are sealably received within the body of the outer locking ring.

10. A sealing assembly for an apparatus for converting a liquid into a semi-frozen or frozen form, the apparatus having an outer wall and an inner wall forming a refrigerant cavity, and each wall has an outwardly-directed peripheral flange about a respective mouth portion;
the sealing assembly including:
a top locking ring having an annular wall with an outer peripheral flange with at least one inwardly-directed locking formation; and
a bottom locking ring having an annular wall having an upper portion with a rim to be received within the outer peripheral flange, the annular wall having at least one outwardly-directed locking formation complementary to the inwardly-directed locking formation;
so arranged that:
when the inner wall is located within the outer wall with their respective peripheral flanges co-axially aligned, and the peripheral flange of the outer wall is engaged with the rim, locking engagement of the inwardly- and-outwardly directed locking formations causes the peripheral flanges of the inner and outer walls to be sealably clamped between the annular wall of the top locking ring and the rim of the bottom locking ring.

11. The sealing assembly of claim 10, wherein:
the annular wall of the lower locking ring has an annular recess;
both the inner and outer walls have lip flanges about their peripheral flanges; and
the lip flanges are sealably received in the annular recess.

12. The sealing assembly of claim 10 or claim 11, wherein:
the top locking ring further includes an inner peripheral flange, on an opposed side of the annular wall.

13. The sealing assembly of claim 12, wherein:
the inner peripheral flange forms a lower portion of a removable cover for the apparatus, or has at least outwardly-directed locking formation for releasable engagement with a removable cover for the apparatus.

14. The sealing assembly of any one of claims 8 to 13, wherein:
the locking formations comprise one or more screw-threads, bayonet coupling members or like releasable formations.

15. The sealing assembly of any one of claims 8 to 14, wherein:
a flexible wall overlies the mouth portions of the inner and outer walls and is clamped between the annular wall of the top locking ring or outer locking ring and the peripheral flange of the inner wall.

16. The apparatus of claim 1, enclosed in a cover formed of semi-rigid or soft materials.

17. An apparatus for converting a liquid into a semi-frozen or frozen form, including:
an outer wall and an inner wall forming a refrigerant cavity; and
a refrigerant material at least partially filling the refrigerant cavity, the refrigerant material being able to be cooled below a freezing temperature of the liquid to at least partially-freeze the liquid to form a semi-frozen slurry and/or frozen particles when the liquid is brought into contact with the inner wall; wherein:
the outer wall and inner wall are sealably connected together by the seal assembly of any one of claims 8 to 15.

18. The apparatus of claim 17, enclosed in a cover formed of semi-rigid or soft materials.

19. An apparatus for converting a liquid into a semi-frozen or frozen form, including:
an outer wall and an inner wall sealably connected together to form a plurality of refrigerant cavities; and
a refrigerant material at least partially filling each one of the refrigerant cavities, the refrigerant material being able to be cooled below a freezing temperature of the liquid to at least partially-freeze the liquid to form a semi-frozen slurry and/or frozen particles when the liquid is brought into contact with the inner wall.
